(19) United States
(12) Patent Application Publication
(10) Pub. No.: US 2012/0102680 A1
(43) Pub. Date: May 3, 2012

(54) Three-Hole Utility Hook

(76) Inventor: Joseph Alfred Leon, Bakersfield, CA (US)

(21) Appl. No.: 12/916,521

(22) Filed: Oct. 30, 2010

(51) Int. Cl. F16G 11/00; A44B 13/00

(52) U.S. Cl. 24/129 R

(57) ABSTRACT

A three-hole utility hook made of metal or plastic material, possibly coated with polyvinyl or rubber, for elastic fastening and securing cables. A structural component designed to anchor: rubber cables, cords, ropes, and other tie down components in order to secure an item.

### CROSS-REFERENCE TO RELATED APPLICATIONS

U.S. Pat. No. 4,432,121 Jun. 18, 1981 Dupre

D524636 Jul. 11, 2006 Burnett D8/367

D395390 Jul. 1, 1996 Etheron D8/370

D415673 Nov. 9, 1998 Hampshire D8/367

### BACKGROUND OF THE INVENTION

The present invention is directed towards tools and hardware; more particularly a hook for elastic fastening and securing cables comprising a head portion forming a hook and a body thereof containing three open holes. The description is so that the present invention may be completely understood and appreciated in its proper context. Many times hooks are made in an s-shape limiting where the hook can be used on a tie down cable and sometimes you don't have the ability to knot a tie down component because it's too rigid. Therefore, by being able to insert a tie down cable through three separate holes this allows the tie down cables to not have to be pre-holed or knotted once the tie down cable is used to secure an object. By tethering the tic down cables through holes A, B, and C we accomplish a secure tie down utility hook.

We all benefit when any item is created to do a multitude of operations such as securing various tie down components. This utility hook will allow flat or round tie down cables to be used for securing truckloads, boats, tarps, or any other object needing to be tied in place. This tie down component is well suited when trying to use rubber strips from recyclable sidewalls from car or truck tires.

### BRIEF SUMMARY OF THE INVENTION

In accordance with a first characteristic of the invention. the utility hook is noteworthy in that it includes a hook shaped head having a lower portion thereof parallel to the hook shaped head. Said parallel portion of the utility hook is rectangular in shape and has three open rectangular slots in order to feed a tic down component through said openings with the excess of the tic down component coming back through the. opening farthest from the hook shaped head. When fastened under stress the tic down component will be tethered to one another when coming back through the rectangular opening farthest from the hook shape head.

### DETAILED DESCRIPTION OF THE INVENTION

The three-hole utility hook made of metal or plastic material is used with rubber cables, cords, braided rope, or other tie down components to be used as a means of securing objects in place. The three hole utility hook is in a J-like form with the two rectangular holes closest to the hook, Figures B and C, being the same length and width, the third rectangular hole furthest from the j-hook, Figure A, being larger in size compared to the first rectangular holes in length not width. Figures B & C both measure anywhere between ⅛ inch to 6 inches in width and 1/16 inch to 8 inches in length; while figure A measures in anywhere from ⅛ inch to 6 inches in width and ⅛ inch to 10 inches in length, respectively. The steel or plastic material used to create the three-hole utility hook can measure at 0.0500 inch thickness to 2 inches thickness. The length of the top hook will, measure in at approximately ¼ inch to 9 inches while the following body will measure at ½ inch to 12 inches; the total length of the hook and body should measure at ¾ inch to 14 inches in approximation. The object to be placed {in the hook} should be inserted in a weaving motion. Starting at figure A, to figure B, to figure C, and ends back at the initial start point, the hole which is the largest, figure A.

### BRIEF DESCRIPTION OF THE SEVERAL VIEWS OF THE DRAWINGS

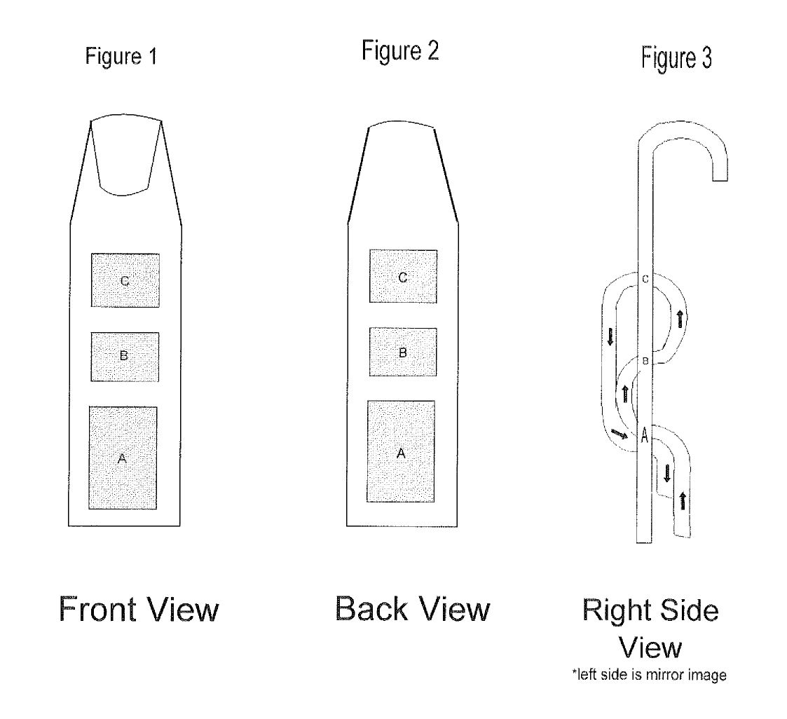

A. FIG. 1 represents a front. view of the three-hole utility hook.

B. FIG. 2 represents a hack view of the three-hole utility hook.

C. FIG. 3 represents a right side view of the three-hole utility hook with a tie down component woven through holes A, B, and C.

1. A three-hole utility hook, made of metal or plastic, used for elastic fastening and securing cables as a method of anchoring various tie down components.

2. A method as in claim 1 wherein said three-hole utility hook can be used as a tie down component for reinforced rubber cable strips from recycled waste tires.

3. A method as in claim 1 wherein said three-hole utility hook can be used with woven nylon webbing or nylon rope tie downs.

4. A method as in claim 1 wherein said three-hole utility hook can be used with woven cotton webbing or cotton rope.

5. A method as in claim 1 wherein said three-hole utility hook can be used with woven hemp webbing or hemp rope.

6. A method as in claim 1 wherein said three-hole utility hook can be used with woven metal webbing or metal cable.

7. A method as in claim 1 wherein said three-hole hook is in (J) form.

8. Said three-hole utility hook consists of three major rectangular holes in center of object figures B & C both measure anywhere between ⅛ inch to 6 inches in width and 1/16 inch to 8 inches in length.

9. Said three-hale utility hook the figure A measures in anywhere from ⅛ inch to 6 inches in width and ⅛ inch to 10 inches in length.

10. Said three-hole utility hook the total length of the hook and body should measure at ¾ inch to 14 inches in approximation.

11. As in claim 7, The steel or plastic material used to create the three-hole utility hook can measure at 0.0500 inch thickness to 2 inches thickness

12. As in claim the length of the top hook will measure in at approximately ¼ inch to 9 inches.

13. The three-hole utility hook total length of the hook and body should measure at ¾ inch to 14 inches in approximation.

14. As in claim the three-hole utility hook body will measure at ½ inch to 12 inches.

15. OBJECT first inserts to front of FIGURE A, then proceeds to insert to rear of FIGURE B, following insert at front to FIGURE C, object then inserts up and around into the rear of FIGURE A, as shown.
